(19) United States
(12) Patent Application Publication
(10) Pub. No.: US 2026/0013449 A1
(43) Pub. Date: Jan. 15, 2026

(54) SYSTEMS, DEVICES, AND METHODS FOR MANAGEMENT OF SCHEDULES USED WITH RENEWABLE-ENERGY POWERED IRRIGATION SYSTEMS

(71) Applicant: Massachusetts Institute of Technology, Cambridge, MA (US)

(72) Inventors: Carolyn SHELINE, Cambridge, MA (US); Fiona R. GRANT, Cambridge, MA (US); Georgia D. VAN DE ZANDE, Cambridge, MA (US); Shane PRATT, Cambridge, MA (US); Simone GELMINI, Cambridge, MA (US); Amos Greene WINTER, V, Carlisle, MA (US)

(21) Appl. No.: 18/995,228

(22) PCT Filed: Aug. 14, 2023
(86) PCT No.: PCT/US2023/072178

§ 371 Date: Jan. 16, 2025

Related U.S. Application Data
(60) Provisional application No. 63/371,381, filed on Aug. 12, 2022.

(51) Int. Cl. A01G 25/16; G01W 1/04; G01W 1/10; G05B 13/04

(52) U.S. Cl. CPC A01G 25/165; A01G 25/167; G01W 1/04; G01W 1/10; G05B 13/042; G05B 13/047; G05B 13/048; G05B 2219/2625

(57) ABSTRACT

A tool for management of irrigation schedules is provided. The tool can include a controller that can communicate with an irrigation system to build and implement automatic irrigation schedules using sensed data about the environment, historical data, and manually input data. These schedules can be optimized for capital cost, lifetime cost, farm revenue, water use, and energy efficiency of the irrigation system. The schedule can be adjusted based on sensed data and/or manual inputs to ensure optimal use of resources. In some embodiments, the controller can communicate the schedule to a user via electronic communication to implement irrigation. In such embodiments, the user can interface with the controller to confirm directions to implement irrigation and receive additional directions.

### CROSS REFERENCE TO RELATED APPLICATION

The present disclosure claims priority to and the benefit of U.S. Provisional Application No. 63/371,381, entitled “Controller for Management of Optimal Schedules, Used with Renewable-Energy Powered Irrigation System,” filed on Aug. 12, 2022, the content of which is incorporated by reference herein in its entirety.

### GOVERNMENT RIGHTS

This invention was made with government support under grant number AID-OAA-A-16-00058 awarded by USAID. The government has certain rights in this invention.

### FIELD

The present disclosure relates to systems, devices, and methods for management of irrigation schedules, and more particularly relates to systems, devices, and methods of using predictive irrigation scheduling in combination with renewable source profile matching, while optimizing for water use and energy management, to automatically schedule irrigation events using manual inputs.

### BACKGROUND

Water scarcity and high energy costs can make it difficult for farmers to increase their yields to levels needed to feed growing populations. The number of medium-scale contract farms worldwide is growing, and they are important for feeding the expanding cities in this region. These farms often employ laborers and are characterized by having more advanced equipment than family-owned subsistence farms. These laborers use inexpensive but time-consuming and often imprecise manual methods for determining when to irrigate, like “stick” tests. In these tests, a laborer inserts a stick about ten centimeters into the soil. If the stick comes out with dirt attached thereto, the soil is deemed sufficiently moist. The irrigation experience of hired laborers varies widely, so farmers cannot rely on these binary tests to deliver the most water- and energy-efficient irrigation. Moreover, while human laborers can observe current weather and crop conditions, their forecasts are less accurate than precision irrigation (PI) forecasts. Therefore, existing irrigation control solutions do not meet the needs of small and medium scale farmers at least in low- and middle-income countries.

In a search for more sophisticated irrigation methods, one way for countries to sustainably increase food production is to increase the adoption of water- and energy-efficient irrigation technology, such as solar-powered drip irrigation systems. For example, conventional solar-powered drip irrigation can help increase irrigation adoption, particularly on medium-scale contract farms (sized approximately in the range of about 5 acres to about 15 acres), as in East Africa (EA), and larger contract farms, as Middle East/North Africa (MENA).

There is a growing demand for solar-powered drip irrigation among medium-scale contract farmers due to water scarcity and the high operational costs of electricity and fuel in regions like EA and MENA. These systems can provide many benefits to farmers who are able to install them on their fields, but these conventional solar-powered drip irrigation systems have several shortcomings. First, a significant barrier to adoption exists due to the high capital costs of this equipment and the technical complexity thereof. Second, conventional irrigation system controllers cannot integrate the long-term energy performance of the system with local weather forecasts or specific irrigation needs of the farms. Rather, these conventional irrigation system controllers can design for an irrigation schedule of an average day, without accounting for the lifetime performance of the system, which can have significant impact on farmers' profits. Third, current design methods for irrigation systems also may not take into account both the lifetime performance and the daily irrigation schedules, leading to improperly sized systems. Still further, when irrigation engineers design systems, the system component interactions and the system performance may not be comprehensively modeled. Lack of comprehensive modeling can lead to systems that are not reliable and are prone to failure in inopportune moments that can compromise a farmer's crop for days, weeks, or even months. Existing systems are reactive to current conditions and lack predictive capabilities.

Accordingly, there is a need for a tool that can create automated complex irrigation schedules that can be gathered using low-cost equipment.

### SUMMARY

The present application is directed to a tool for management of irrigation schedules. The tool can include a novel low-cost, holistic irrigation controller that can manage a variety of agricultural contexts, e.g., crops, locations, soil types, and so forth, as well as manage the system requirements, e.g., energy use, pressure, flow, and so forth. The controller can pair with renewable energy powered irrigation systems to build and implement automatic irrigation schedules using minimal data about the farm, local weather, and crops grown. These schedules can be optimized for parameters of an irrigation system such as capital cost, lifetime cost, farm revenue, water use, and/or energy efficiency. The controller can implement the schedule, for example, by communicating with a user via text message or another electronic communication service to control irrigation. In some embodiments, the controller can combine water use optimization with energy management optimization to increase crop yields, reduce operational costs, and maximize efficiency of the irrigation system that is in communication with the controller. In comparison to existing systems and tools in the prior art, the present systems and tools are predictive in nature rather than reactive, and can communicate an optimal irrigation schedule directly to the user.

One exemplary embodiment of an irrigation tool includes a controller in communication with an irrigation system and a farm to receive one or more inputs therefrom to create an irrigation schedule. The controller is configured to create a predictive model of the irrigation system based on the one or more inputs, and optimize energy and water use to produce an optimal irrigation schedule using the predictive model. The controller is configured to optimize the irrigation schedule using optimal control based on the predictive model, and prompt one or more irrigation system components of the irrigation system to operate based on the irrigation schedule.

The one or more inputs can include at least one of historical data, sensed data, or manually input data. The sensed data can include one or more of precipitation, evapotranspiration, solar light, solar irradiance, or water pressure in the irrigation system. The manually input data can include one or more of farm size details, crop selection, growth cycles, drip irrigation layout, or soil type. In some embodiments, the controller can be further configured to predict a weather condition based on the sensed data, and feed the weather condition to the optimal control to create the optimal irrigation schedule. The controller can be in communication with one or more sensors that are configured to gather the sensed data.

The controller can be configured to perform an irrigation scheduling technique with a renewable intermittent source that is predicted with the one or more inputs to calculate at least one of solar power available, evapotranspiration, or crop water demand. The renewable intermittent source can include solar energy. The irrigation scheduling technique can include one or more of profile matching or a single section operation schedule. The irrigation schedule can include profile matching.

In some embodiments, the controller can be in communication with a mobile device of a user, the controller being configured to send and receive prompts from the mobile device. The prompts can include one or more of the irrigation schedule or one or more commands for a user action. The one or more commands can include one or more prompts to manually open or close one or more valves of the irrigation system. For example, the controller can be further configured to update the irrigation schedule based on a prompt received from the mobile device. In some embodiments, the controller can be configured to open or close one or more automatic valves of the irrigation system. The one or more irrigation system components can include a pump, a solar panel, one or more of a manually operated vale or an automatic valve, and one or more of a tank or a power source battery. In some embodiments, the controller can calculate soil moisture data without being in communication with soil moisture sensors.

One exemplary method of irrigation includes using a controller in communication with an irrigation system and a farm to create an irrigation schedule based on one or more inputs received from the irrigation system or the farm, optimize energy and water use to produce an optimal irrigation schedule, optimize the irrigation schedule using optimal control based on based on a model of the irrigation system that allows for predictions of future system behavior, and prompt one or more components of the irrigation system to operate based on the irrigation schedule.

The method can further include performing profile matching with a renewable intermittent source that is predicted with the one or more inputs to calculate at least one of solar power available, evapotranspiration, or crop water demand. The optimal control can be a model predictive control (MPC). The optimal irrigation schedule can include profile matching.

In some embodiments, the method can further include communicating, using the controller, with a mobile device to send and receive prompts from the mobile device. The method can further include adjusting the irrigation schedule, using the controller, based on a prompt received from the mobile device. The prompt can include one or more of the irrigation schedule or one or more commands for the user. The one or more commands can direct for manually opening or closing a valve of the irrigation system based on the command.

Creating the irrigation schedule can further include creating a predictive model based on agronomy models and weather data that are used to create the irrigation schedule. The predictive model can be created in approximately a range of about sub-hourly to about one week in advance of operation based on the irrigation schedule. In some embodiments, the method can further include adjusting the predictive model, using the controller, between a time that the predictive model is created and a time in which one or more components of the irrigation system is prompted to operate based on the irrigation schedule. The method can further include adjusting, using the controller, one or more of the irrigation schedule, amount of power available, or pumping power in response to changes in weather patterns, soil water balance, sensed data, or manual inputs into the controller. Optimizing energy use can further include extending a battery life of a battery associated with the irrigation system.

### BRIEF DESCRIPTION OF THE DRAWINGS

This disclosure will be more fully understood from the following detailed description, taken in conjunction with the accompanying drawings, in which:

FIG. 1 is a schematic diagram of an example embodiment of an irrigation system in communication with a controller of the present embodiments that outputs information to a user;

FIG. 2 is a schematic illustration of the sensed information and inputs gathered by the controller of FIG. 1 to create an irrigation schedule;

FIG. 3A is a graph illustrating operation of an irrigation system without profile matching as disclosed in the present embodiments;

FIG. 3B is a graph illustrating operation of an irrigation system with profile matching as disclosed in the present embodiments to reduce the required power system capacity (panels and battery) by closely matching the irrigation load to the available solar irradiance;

FIG. 3C is a graph illustrating operation of an irrigation system with profile matching as disclosed in the present embodiments to efficiently use power by using smaller panels and little to no excess battery;

FIG. 4A is a schematic illustration of an irrigation tool of the present embodiments;

FIG. 4B is a schematic illustration of a sequence of interaction between a user and the irrigation tool of FIG. 4A;

FIG. 5A is a schematic illustration of one embodiment of a controller architecture of the controller in communication with the irrigation system of FIG. 1;

FIG. 5B is a schematic illustration of each level of the controller architecture of FIG. 5A; and

FIG. 6 is a schematic diagram of one exemplary embodiment of a computer system upon which the control system of the present disclosures can be built.

### DETAILED DESCRIPTION

Certain exemplary embodiments will now be described to provide an overall understanding of the principles of the structure, function, manufacture, and use of the devices and methods disclosed herein. This includes in the description and claims provided for herein. Further, one or more examples of these embodiments are illustrated in the accompanying drawings. Those skilled in the art will understand that the devices and methods specifically described herein and illustrated in the accompanying drawings are non-limiting exemplary embodiments and that the scope of the present disclosure is defined solely by the claims. The features illustrated or described in connection with one exemplary embodiment may be combined with the features of other embodiments. Such modifications and variations are intended to be included within the scope of the present disclosure.

To the extent that the instant disclosure includes various terms for components and/or processes of the disclosed systems, methods, and the like, one skilled in the art, in view of the claims, present disclosure, and knowledge of the skilled person, will understand such terms are merely examples of such components and/or processes, and other components, designs, processes, and/or actions are possible. Additionally, a number of terms may be used throughout the disclosure interchangeably but will be understood by a person skilled in the art. By way of non-limiting example, the terms “farmer” and “user” may be used interchangeably with one another to refer to an individual that interfaces with the controller of the present embodiments. This individual may be a manager, a laborer, a supervisor, an independent contractor, or the like.

The present disclosure provides for an irrigation system that is in communication with an irrigation tool or an irrigation system control or controller that can help farmers predict their irrigation needs. For example, the irrigation tool of the present embodiments can include an automatic scheduling component that integrates with a manual operation component to facilitate irrigation of a specific area. The irrigation tool can include a controller that can determine complex irrigation schedules based on parameters such as local weather predictions and specifics of a given farm. Moreover, the controller can optimize for the lifetime performance of the irrigation system, which can lower the lifetime costs of irrigation systems, e.g., solar-powered drip irrigation systems, and cannot be performed by conventional controllers. Drip irrigation, a type of advanced, water-efficient irrigation, can work by distributing water directly to the root base of crops through a network of pipes. Optimizing the system design and operation of irrigation systems can lead to significant cost reductions of solar-powered drip irrigation without reducing system performance. This system design can create sustainable irrigation technology and easy to follow recurring irrigation schedules as support for making sustainable and precise irrigation decisions on a daily basis. In some embodiments, the controller of the present embodiments can communicate this schedule to farmers to allow them to continue to use low-cost, manually-operated valves on their fields. If adopted at scale, the controller can help lower the barrier to adopting water and energy-efficient irrigation, ultimately having a positive, sustainable impact on food security in various other regions of the world, such as East Africa and MENA.

Previous work has shown that system operation has a significant impact on the energy efficiency, water use efficiency, and cost of renewably-powered irrigation systems, yet the design and control of these systems often fails to consider how they are best operated. Agricultural systems are complex, multivariate, and unpredictable and operate over multiple characteristic timescales, which makes them difficult to control using classical control techniques. Rather, agricultural systems can be well suited for control schemes such as optimal control, which when combined with load scheduling and/or solar-profile matching, which are discussed in greater detail below, can increase crop yields, optimize water and energy management, and/or prolong the useful life of components of the irrigation system, among other benefits. Optimal control can include a process control, e.g., model predictive control (MPC), which can use a dynamic model of the system and optimize the irrigation schedule and energy management.

At least one novel aspect of the irrigation tool of the present disclosure includes integration of concurrent optimization of water and energy use with predictive modeling and solar profile matching to create automatic irrigation schedules for an irrigation system. Optimization of both water and energy concurrently, which is not performed by conventional systems, can increase system efficiency and greatly reduce costs. Moreover, use of predictive modeling, as opposed to making retroactive schedule adjustments, can allow the irrigation tool to communicate a schedule to farmers in advance. When predictive modeling is combined with profile matching, the presently disclosed tool can increase system reliability, especially on cloudy days, and, has the potential to reduce the power of the system by up to approximately 80% without sacrificing reliability, e.g., predictive modeling combined with profile matching have an increase in reliability of about 31% to about 66%.

Existing irrigation control solutions have several shortcomings with respect to the needs of small and medium scale farmers in low- and middle-income countries. These existing controllers offer either no control or single-component control to farmers, both of which are deficient with respect to meeting farmers' needs. Controllers that offer no control account for farmers' reliance on observation/experience and do not realize the benefits of new irrigation technologies. Single-component control devices, meanwhile, can manage operation of a single component or element of the irrigation process (e.g., pump, irrigation timer), but do not integrate management of all subsystems. Moreover, each of these types of controllers are often timers coupled with some sensors that require the user to input a schedule, i.e., rely on user expertise and decision making. Precision irrigation control systems may have more capabilities, but to the extent they do, they are typically highly expensive and technically complex because, at least in part, on their reliance on many integrated sensors, system monitoring technology, and the need for technical expertise in calibration and operation.

### Controller

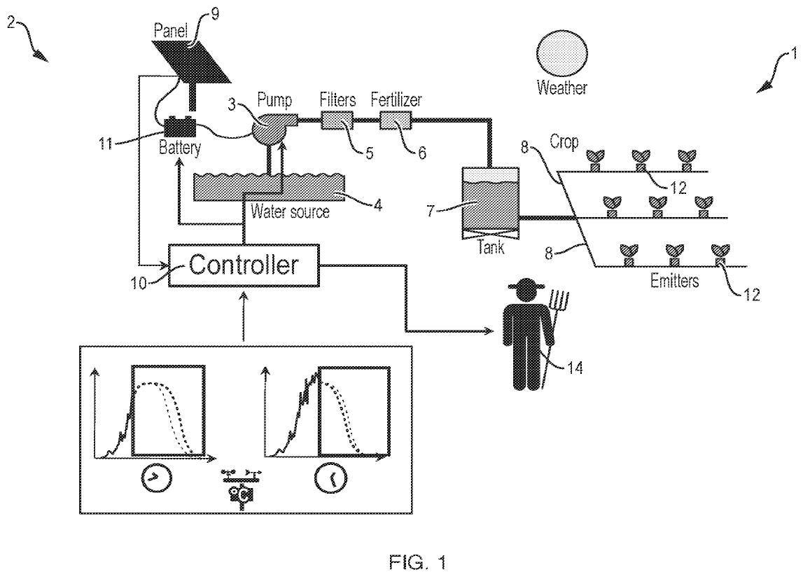

FIG. 1 illustrates an example embodiment of a farm 1 that is in fluid communication with a solar-powered drip irrigation system 2 for irrigation. A person skilled in the art will recognize that while the controller of the present embodiments will be discussed in the context of solar-powered drip irrigation systems, it can be implemented for any energy source that is variable and predictable while using minimal sensors and/or any farm architecture that can use multiple sections and could use multiple operating points to irrigate.

As shown, the system 2 can include a pump 3, e.g., a solar pump, which can deliver water from a water source 4, e.g., a borehole, through one or more of a filter 5 and/or a fertilizer injector 6 to a tank 7. The tank 7 can be a raised tank that is in fluid communication with a network of pipes and/or drip lines 8 such that the water can flow through the network as needed. In some embodiments, the pump 3 can be powered by one or more solar panels 9, and energy can be stored, e.g., in batteries 11 and/or in the raised tank 7. The drip lines 8 can have one or more emitters 12 that deliver water directly to the root zones of crops. The irrigation system 2 of the present embodiments can reduce activating pressure to reduce pumping power and power costs, while also ensuring that the sections all operate at the correct pressure so that the emitters in a given section can be at activation pressure such that the section receives uniform flow. Moreover, in some embodiments, the irrigation system 2 can detect clogging and alert users to maintenance needs and/or replacement of one or more parts of the system. While the system 2 is shown with respect to a single water source 4, the system 2 can, in some embodiments, be flexible to a wide variety of contexts, which may include various water sources, including a plurality of water sources and/or hydraulic system configurations. A person skilled in the art, in view of the present disclosures, would understand how this diagram would change if there were multiple water sources, and thus an illustration that shows multiple waters sources is unnecessary.

A central controller, irrigation controller or controller 10, can be used to help the farmer operate the system 1. As shown, the controller 10 can interface and/or otherwise be in communication with the irrigation system 2, e.g., the pump 3, and/or the power source, e.g., battery, 11 to control an output thereof, as discussed in greater detail below. For example, the controller 10 can optimize drip irrigation schedules for water use, efficiency, and/or system costs. In some embodiments, the irrigation controller 10 can use a weather station and/or machine learning to predict on-site weather for the farm 1. It will be appreciated that in some embodiments, the weather station can be local to the farm on which irrigation occurs, which provides accurate weather data as weather can vary even across a single farm. For example, the controller 10 can use the predictions in combination with one or more of farm crop and soil inputs to calculate the exact water needs of the crops. Some additional non-limiting examples of inputs for generating an optimal irrigation schedule can include operating pump power, pump pressure, and/or pump flow rate for each section and each combination of sections, number of sections, field area, power electronic specs (e.g., panel, battery, inverter, VFD, other electronics), initial soil moisture condition/content, crop type (related crop parameters can be default values or measured), planting and harvest dates, soil texture, soil wetted fraction, the irrigation type (e.g., drip, sprinklers, etc.), local historical and current measured weather data (e.g., temperature, relative humidity, solar radiation, rain, and/or wind speed), among others. Moreover, the controller 10 can use inputs from the solar panel 9 to predict the solar power available over the course of a day. The controller 10 can be in communication with a user 14, e.g., a farmer to communicate the irrigation schedule thereto and/or receive inputs therefrom.

In some embodiments, the controller 10 can use one or more sensors 16, e.g., approximately in a range of about one to about ten, approximately in a range of about two to about eight, and/or approximately in a range of about four to about six, to create complex irrigation schedules. In some embodiments, the controller 10 can use a single pressure sensor in combination with a weather station (e.g., rain, solar radiation, wind speed, temperature and humidity sensors), though additional sensors can be added to improve accuracy. The sensors 16 can be low cost sensors to reduce the overall cost of the controller to accommodate use in small and medium-sized farms, and further, the number of sensors used can be kept to a minimum (e.g., no more than 10 sensors) in view of the other features of the disclosed systems. The controller 10 can use the sensors 16 to perform a calculation of the solar power available, evapotranspiration, system power/pressure and energy use, and/or crop water demand, among other computations. Moreover, the controller 10 can use data gathered by the sensors 14 for automatic scheduling while retaining the benefits of manual operation. For example, in some embodiments, the sensors 14 can be used to create irrigation schedules while continuing to use low-cost equipment on the fields (e.g., manual valves), which keeps the solution within a price range affordable to a low-income farmer. In some embodiments, the user 14 can automate the schedule to rely solely on automation without manual operation, e.g., create an automatic irrigation schedule which controls the valves automatically without relying on manual valve operation, if the user chooses.

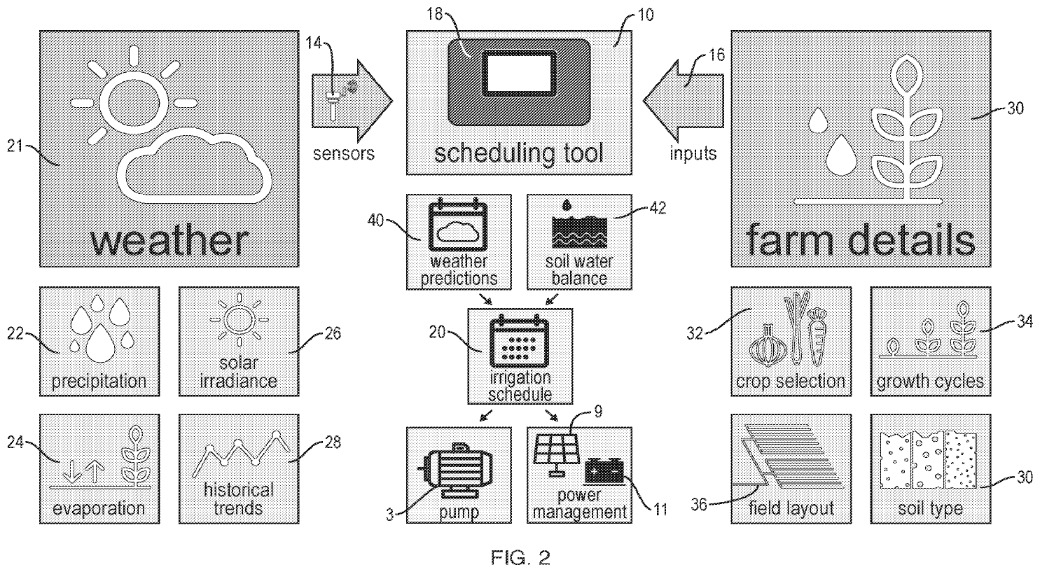

In some embodiments, data inputs by the controller 10 can be gathered automatically as sensed data and/or via manual inputs 16. FIG. 2 illustrates an example of data used by a scheduling tool 18 of the controller 10 to create an irrigation schedule 20. As shown, the controller 10 can gather sensed and historical weather information to calculate evapotranspiration. Some non-limiting examples of sensed data can include weather 21, precipitation 22, evaporation 24, solar irradiance 26, and historical weather data 28, e.g., meteorological year data or data collected by a local weather station, can include precipitation, temperature, relative humidity, solar information (e.g., gather by a light sensor instead of an irradiance sensor to keep costs low, though irradiance sensors are also possible), and/or wind trends over a given time period. Some non-limiting examples of farm details 30, such as crop selection 32, growth cycles 34, drip irrigation layout 36, and/or soil type 38, among others, can be manually input by the user 14. Additional examples of inputs into the system can include electronic power or pump operating power/operating points for the irrigation section combinations, and a pressure measurement that can be used in a pump speed control feedback loop, as discussed with respect to the controller architecture below. Using the sensed and input data, the controller 10 can make short term weather predictions 40, and/or calculate the soil water balance 42 to determine an optimal irrigation schedule 20 from an agronomy and system energy management standpoint based on crop water demand. It will be appreciated that these short term weather predictions 40 can be approximately in a range of about one day out to about ten days out, approximately in a range of about two days out to about eight days out, approximately in a range of about three days out to about seven days out, approximately in a range of about four days out to about six days out, and/or about five days out. The irrigation schedule 20 can then be relayed to components of the irrigation system 2, e.g., the pump 3 and power management components such as the solar array 9 and/or the battery 11. This information can be retained by the controller 10 and updated in real-time. In some embodiments, the controller 10 can be configured to adjust one or more of the irrigation schedule 20, amount of power available, pumping power, and the like, in response to changes in weather patterns, soil water balance 42, sensed data, and/or manual inputs into the controller.

For example, in use, the controller 10 can calculate the water needed by crops over a specific number of sections on an example farm 1. Moreover, the controller 10 can calculate and/or predict the solar power available over a day. Without a controller, the sections may be turned on sequentially, which can require use of a large number of solar panels to meet the energy and water demands at the beginning and end of the day when solar irradiance is low. With the controller of the present embodiments, the irrigation schedule can calculate the irrigation demand and spread it over two or more days by irrigating the sections in an energy efficient manner and/or implement solar profile matching, as discussed in greater detail below. Moreover, use of the controller 10 can perform irrigation of the farm with fewer solar panels 9 and/or a smaller battery 11, which further decreases costs of the irrigation system 2.

At least one novel aspect of the controller 10 of the present embodiments can therefore include the use of predictive irrigation scheduling in combination with profile matching to schedule irrigation events. Knowing the available power and crop water demand in advance and having a well-characterized power and hydraulic system can allow for the use of a process control technique, such as model predictive control (MPC), which can use a dynamic model of the system and optimize the irrigation schedule and energy management. This technique can be paired with “profile matching” or “solar profile matching” (SPM), which is an energy-efficient method that includes using the shape of an available solar power curve to irrigate a higher volume of water at times of high power and a lower volume of water when there is less power available. That is, profile matching can be a way to schedule the irrigation and MPC can be a way to optimally control a process using a dynamic model of a system to optimize over a time window that includes the current time and the predicted future behavior of the system, e.g., a chemical reactor, to model the future of the system. It will be appreciated that while profile matching may be discussed with respect to solar energy in this disclosure, for the purposes of this disclosure, profile matching can occur with any renewable intermittent source that can be predicted using weather data. Profile matching can be accomplished by turning a different number of sections on the field throughout a given day on and/or off. Compared to sequential scheduling of irrigation events, profile matching can use a smaller solar power array with some small amount of energy storage as a buffer. This allows for a reduction in the power system cost compared to current solar-powered drip irrigation systems. In some embodiments, the controller 10 can output an optimal irrigation schedule that includes profile matching.

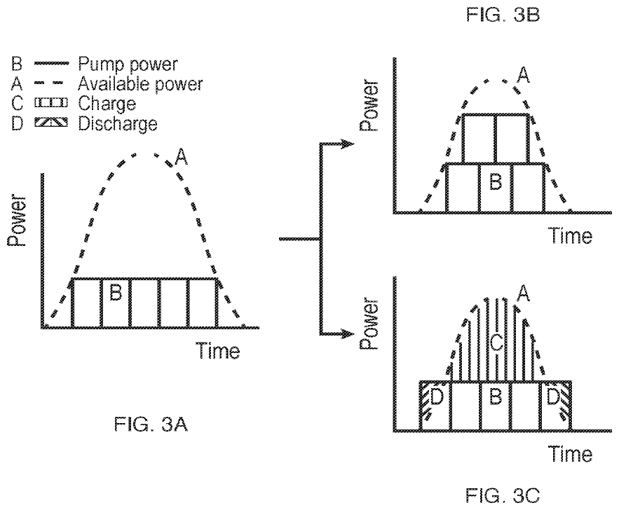

FIGS. 3A-3C, for example, illustrate an exemplary depiction of how solar profile matching can be accounted for and, in turn, utilized in conjunction with setting an irrigation schedule (e.g., the irrigation schedule 20). In solar profile matching, irrigation events are scheduled, e.g., load scheduled, to match an anticipated pumping energy needed to meet water demand with the forecasted available power. As shown, for a solar-powered system to irrigate, the solar power available, e.g., irradiance curve (curve A), can fully encompass the power and/or energy used to pump water to the field in blocks or sections (B). Fields can be irrigated in sections, with each block (B) representing the irrigation event for a single section, and the energy blocks (B) for each section of the farm 1 being fit under the irradiance curve (curve A). Put another way, in solar profile matching, energy blocks for each section (B) of the farm are fit under the irradiance curve (curve A), with the size of those blocks (B), which corresponds to pump power, changing day-to-day based on irrigation needs, expected weather, and the like. When used in combination with predictive irrigation scheduling, solar profile matching can create a dynamic schedule based on anticipated weather conditions that can be updated in real-time, which is one way by which the tool of the present embodiments distinguishes from conventional irrigation systems.

FIG. 3A represents operating a system without profile matching, with only one section being irrigated at a time, and the blocks (B) being irrigated in series. FIG. 3B illustrates an example of profile matching in which a reduction in power can be possible by irrigating multiple blocks during times of high solar irradiance. While energy storage is not used in this example, energy management can be optimized. FIG. 3C illustrates profile matching in an example embodiment in which the battery 11 is charged (C) during times of high solar power availability and discharged (D) to irrigate during low irradiance periods, which also increase power efficiency and optimizes energy management. Either of the profile matching examples of FIGS. 3B and 3C, or a combination of the two, can allow for a more efficient use of the solar power available, thereby reducing the number of panels used to irrigate a given field.

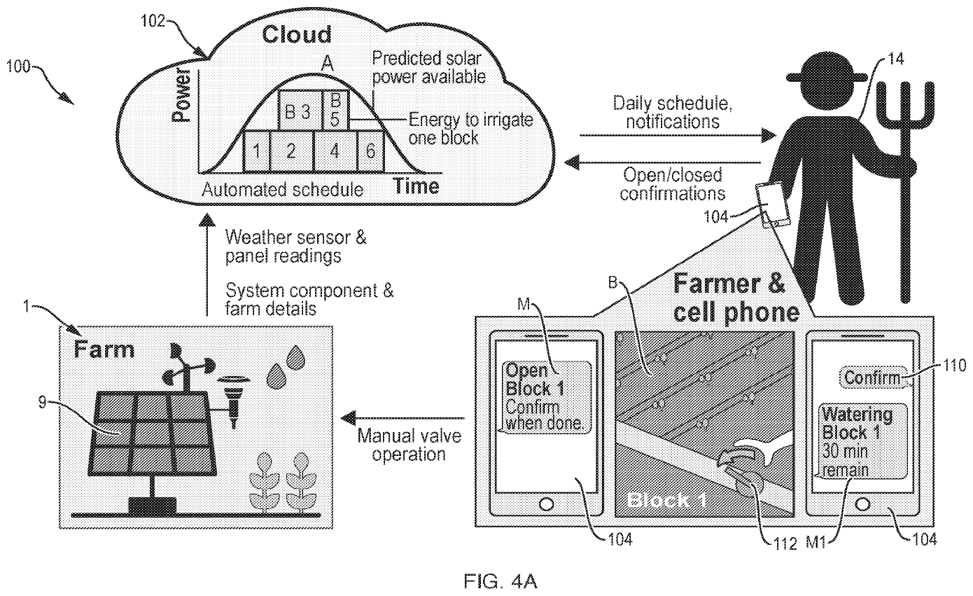

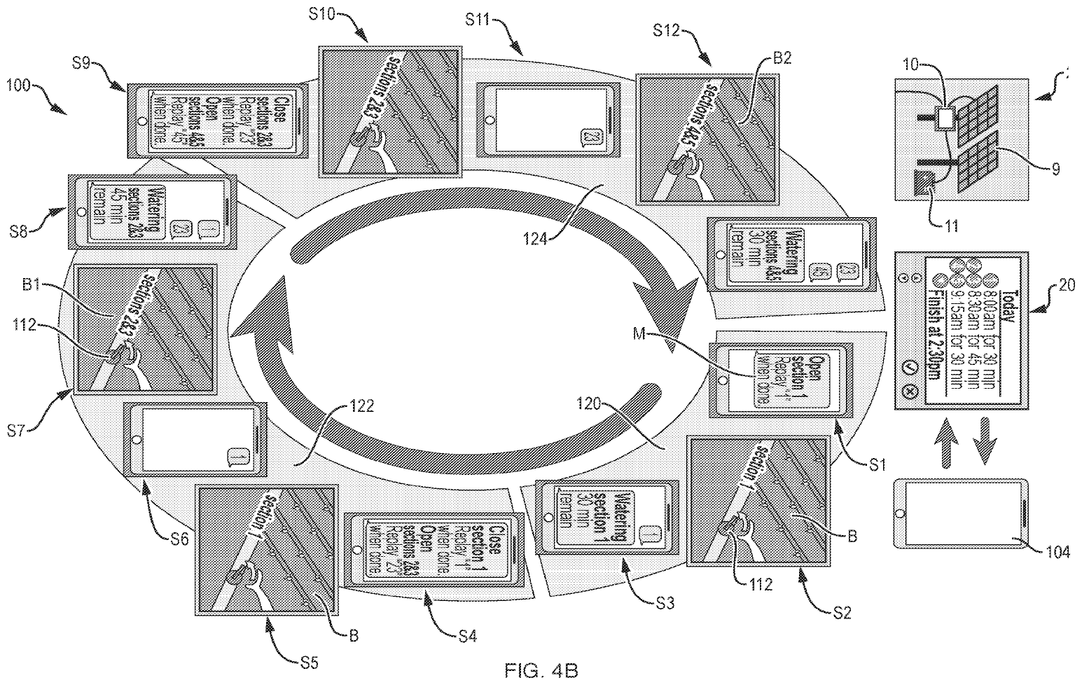

Profile matching, as discussed above, can create complex irrigation schedules that use low-cost automation to provide feedback for the calculations of the controller 10. To achieve low-cost automation, the controller 10 can implement a novel, Short Message Service (SMS)-based user interaction with a user. For example, FIG. 4A illustrates an example embodiment of a scheduled irrigation event 100 for the tool of the present embodiments. At the beginning of the day, or alternatively, a certain amount of time prior to the day in question, the controller 10 can use the graphs of FIGS. 3B-3C to schedule the irrigation event 100. The controller 10 can leverage cloud computing and predictive modeling, as well as several inputs, such as weather sensor and solar panel power readings, to characterize the status of the farm, e.g., soil moisture content. The creative model can include a model of the irrigation system 2 that can allow for predictions of future system behavior. Conventional scheduling methods utilize soil moisture sensors, which are expensive and complex to calibrate, to characterize a status of the farm. In contrast, the controller 10 of the present embodiments can leverage cloud computing 102, and other features of the present disclosure, to characterize soil moisture without the use of these sensors. For example, as shown in FIG. 4A, the controller can use water balance calculations and one or more inputs from the farm 1, including readings from simple weather sensors, power readings from a solar panel 9, and/or user inputs, e.g. system component specifications, solar array capacity, pump operating points, irrigation block areas, crop types, and/or soil texture, to schedule irrigation events to match an anticipated pumping energy needed (B) to meet water demand with the forecasted available power (A). This energy needed to irrigate the blocks (B) can then be fit under the anticipated irradiance curve (A) based on the predicted power available to allocate the power to each block, as discussed above.

Irrigation system control of the present embodiments can schedule irrigation events and operate valves in a hydraulic network to irrigate increase water use efficiency on farms, reduce costs, and provide users with real-time feedback about their systems, while leveraging farmer expertise and integrating into existing labor practices. Moreover, the irrigation tool of the present embodiments can rely on both manual and automatic features that can work simultaneously to achieve maximum efficiency and output, while minimizing cost. For example, the irrigation system control of the present embodiments can provide automatic scheduling, such as in precision irrigation (PI), while relying on manual operation. This combination of automatic scheduling and manual operation can allow users, e.g., farmers, irrigation system designers, and engineers, to input parameters such as farm location, farm size, water source, and/or desired crops, and output an optimized solar-powered irrigation full-system design with guaranteed energy and water-delivery performance indicators as well as indicators for system cost and yield revenue.

The cloud computing 102 can use these farm inputs, as well as various additional farm details, to determine the predicted solar power available and/or the energy to irrigate one block (B), as discussed with respect to FIGS. 3B-3C above. The controller 10 can then calculate an ideal, efficient irrigation schedule using the predicted crop water needs and available energy. Once calculated, the controller 10 can communicate this schedule to one or more user 14 through a mobile device, e.g., a phone 104 with easy to follow instructions. The phone 104 can be a smartphone or another device that runs a specific software application and/or receives SMS-based user interaction via a user interface (UI) with a user. As shown in FIG. 4A, the controller 10 can send messages M to the phone 104 to remind them to manually open or close one or more valves 112. The user 14 can then manually open or close valves as directed, sending a confirmation SMS 110 to confirm completed actions.

Once the confirmation SMS 110 is sent, a new instruction message M1 can be sent to the user 14. For example, once the confirmation SMS 110 indicates that a valve 112 for a given block (B) has been opened, the controller 10 can note the start time of the irrigation event and can tell the farmer when it is set to end (e.g., “Irrigating Section 1 for 30 minutes.”). As shown in FIG. 4A, for example, the SMS can read “Open Block 1 Confirm when done,” with the farmer's reply SMS of “Confirm” generating a new instruction (e.g., “Watering Block 1 30 min remain”). When the event ends, the controller can direct the farmer 14 to close the valve with another SMS (e.g., “Close Section 1. Reply with ‘1’ once complete.”). The farmer can manually close the valve 112 to that section, and this exchange can be repeated according to the irrigation schedule that was set. In some embodiments, farmer 14 can reply with another confirmation SMS 110 to indicate that the instruction has been completed, though in some embodiments, the instruction can include a time limit to perform a certain action. The interaction between the controller 10 and the farmer 14 can be flexible in that it can instruct users 14 to open multiple sections at any given time, as instructed by the optimal schedule of the controller (e.g., “Open sections 2 & 3. Reply with ‘23’ once complete,”).

Due to users 14 not opening or closing the valves 112 on time, a confirmation can allow the tool to measure how long each irrigation event is in practice without using sensors throughout the field. This measurement can be used to calculate the duration of future irrigation events. This data can be used in a feedback loop in which the manual valve operation can serve an updated user input that is sent to the farm 1. This updated user input can be detected by the controller 10, which can use this user input to update its cloud computing 102 to calculate an updated value for soil moisture. The back and forth interaction between the tool and the user 14 can then be repeated throughout the day according to the predetermined irrigation schedule. In this manner, the tool can provide automatic scheduling, e.g., calculate and prepare an irrigation schedule, in combination with manual operation, e.g., manual opening and closing of the valves 112 in a block B, which is not found in conventional irrigation processes. It will be appreciated that the tool can be used to instruct other actions besides opening or closing of the valves 112, such as turning off water supply, harvesting crops, scheduling “fertigation” (e.g., scheduling when and how much fertilizer to apply with the irrigation water), regular maintenance and repairs, planting, hiring seasonal labor, help with agronomy task (e.g., weeding, pesticide application, bud snipping, etc.), preventative action to protect crops against inclement weather (using weather predictions), and so forth.

The user 14 can have the option to modify and/or accept the schedule. Communication of the schedule can be performed via SMS 110, with open and/or closed confirmations. Such confirmations can be automated by the system itself. In other words, while the present disclosure describes a system in which the user 14 takes irrigation actions and/or provides responses such as confirming requested actions were taken/have occurred, it is also possible that this system can be fully automated such that user interactions are minimized and/or eliminated. However, even in a system that is fully automated such that user interaction is minimized and/or eliminated, it may be helpful to allow for user actions such as providing interjections and/or overrides, among other actions or tasks appreciated by those skilled in the art, as appropriate. Communications can occur at the start of the day and/or at the start and end of each irrigation event, or more or less frequently as desired.

The interaction between the user 14 and the tool can account for slight user errors. For example, if the user 14 forgets to confirm that a task has been performed, the controller can send a reminder instruction after several minutes. The reminder instruction can update with the correct amount of water delivered based on the time that the SMS confirmation 110 was sent. In some embodiments, the controller 10 can send the same message to a plurality of users to allow multiple people to monitor the irrigation events.

FIG. 4B illustrates an example embodiment of an irrigation event 100 in which a farmer interacts with the controller 10 using SMS reminders in greater detail. For example, at the beginning of the day the controller 10 can tell the farmer 14 the preset irrigation schedule 20, e.g., via phone 104. The farmer 14 can have the option to accept the schedule or make modifications. Once the approved schedule starts with a first direction or command 120 in S1, the controller 10 can send an SMS M with a first instruction S2 (e.g., “Open Section 1. Reply ‘1’ or press ‘Enter’ when done”). The farmer 14 can follow these instructions with respect to block B in S2, confirming when he or she has completed the task(s) with a reply SMS in S3. After the appropriate amount of irrigation time, another SMS is sent to the farmer, telling him or her the next direction 122.

In some embodiments, the next direction 122 can include a plurality of steps to be taken. For example, as shown in S4, the instruction (e.g., “Close Section 1. Reply ‘1’ when done. Open Sections 2 and 3. Reply ‘23’ or press ‘Enter’ when done.”) can be sent via SMS. The farmer 14 can follow these instructions with respect to block B in S5, reply “1” in S6, open the valves 112 of block B1 in S7, and reply “23” in S8, confirming that he or she has completed the direction 122.

This interaction cycle can continue throughout the day, e.g., with sections 4 and 5, until the irrigation schedule is finished. For example, as shown, the next direction 124 in S9 can include the instruction (e.g., “Close Section 2 and 3. Reply ‘23’ when done. Open Sections 4 and 5. Reply ‘45’ or press ‘Enter’ when done.”) can be sent via SMS. The farmer 14 can follow these instructions with respect to block B2 in S9, reply “23” in S10, open the valves 112 of block B2 in S11, and reply “45” in S12, confirming that they have completed the direction 124. It will be appreciated that the text of the direction and/or the replies is merely exemplary and can be varied based on the task and/or desired simplicity or complexity of the communication between the controller 10 and the user 14. In some embodiments, when users confirm completed actions, they can inform the controller 10 how closely the direction was followed so that the irrigation schedule for the following direction and/or the following day can be generated accordingly.

The tool of the present embodiments can be used with either automated or manual valves 112, or a combination of both. For example, farmers can use the tool to create complex irrigation schedules using inexpensive weather sensors while using low-cost equipment on the fields (e.g., manual valves). The ability to use the tool with either valve type can allow farmers to experience the benefits of automatic scheduling while keeping the benefits of manual operation if they cannot yet afford automation and/or prefer to maintain some degree of manual control of their irrigation.

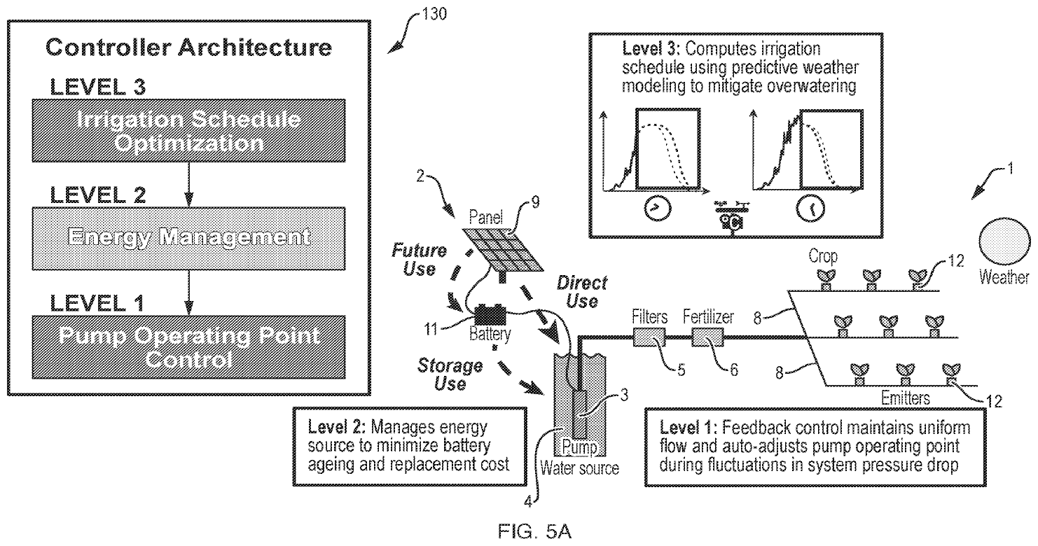

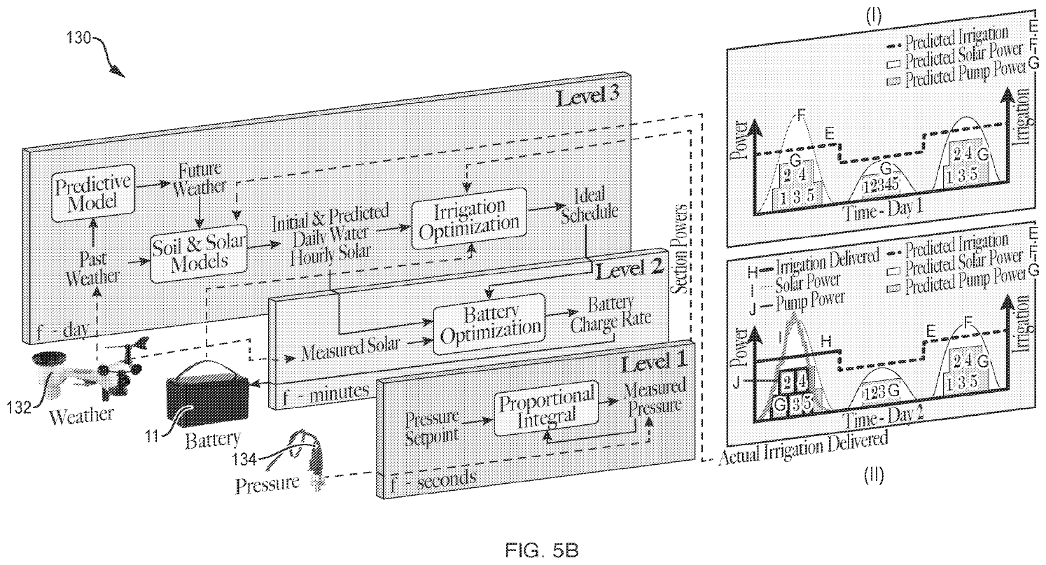

FIGS. 5A-5B illustrate graphic presentations of one embodiment of a controller architecture 130 for the controller 10 in communication with the farm 1 and irrigation system 2 of FIG. 1. The controller architecture 130 of the instant controller 10 can use model predictive control (MPC) to simultaneously predict and optimize energy and water use of the system. The MPC can include an algorithm that can optimize an irrigation schedule, manage energy from energy storage, and/or maintain uniform flow of irrigation, among other things. As shown, the controller architecture 130 can include a three-layer or three-tier hierarchy that can be used to mitigate the uncertainties of the weather prediction and the operation dynamics associated with profile matching. In sequence, Level 3 can use MPC and a large prediction horizon to calculate the optimal irrigation schedule at the start of the day and send this schedule to the user 14. The available and crop water demand over daily to weekly intervals can be determined and optimized to generate an irrigation schedule that delivers the minimum amount of water needed for maximum energy efficiency using concepts such as profile matching, as discussed above. In some embodiments, machine learning can be leveraged to reduce the number of sensors used by the controller 10 without altering sensing capability. For example, in Level 3, the controller 10 can use machine learning and local weather data to make predictions of the crop water demand and available solar power in approximately a range of about sub-hourly to about one week in advance. For the purposes of this disclosure, “about one week” can refer to approximately a range of about five (5) days to about eight (8) days, approximately a range of about six (6) days to about seven (7) days, and/or about seven (7) days. These predictions can be used to create irrigation schedules that are optimized to maximize yield and/or mitigate overwatering within user constraints.

The machine learning algorithm chosen in at least some instances can be vector autoregression (VAR). VAR is a multivariate prediction algorithm that can be well suited for predicting weather data as it is formulated to predict multiple time series data at once that influence each other. VAR can also be an appropriate choice as it can be accurate with limited training data, making VAR an applicable method for farms with little existing local weather data. The VAR model can be defined as:

$${y}_{t} = c + {W}_{1} {y}_{t - 1} + W 2 {y}_{t - 2} + … + {Wpy}_{t - p} + {e}_{t} \qquad ( 4 )$$

where y is a vector of variables being predicted, t is the time, c is a vector of constants, W is a weight matrix, p is the lag order, and e is an error vector. y is comprised of local historical and measured weather parameters. The weather parameters can include: daily average, minimum, and maximum air temperature and relative humidity; daily average wind speed; total daily solar radiation [MJ/m²](G); sun hours calculated as the number of hours the hourly radiation was greater than 0.1 MJ/m2; reference evapotranspiration [mm](ET0) calculated using the Penman-Monteith equation; and precipitation [mm](Pr).

An augmented Dickey-Fuller test can be used to check the stationarity of the data. If the weather data was not stationary, up to two differences of the data can be taken to make the data stationary. The stationary data can be split into training and testing data sets based on, for example, the number of prediction days chosen. The lag order of the VAR model can be chosen by finding the optimal VAR order selection. A VAR model can be built using the time series analysis function in the statsmodels package in Python and fit using the selected lag order. The model can then be used to predict the y vector, and the predicted weather parameters can be used to calculate the solar power and crop water demand. In at least some instances, every time an irrigation schedule is calculated, the time series VAR model can be retrained and re-built, for example using one year of historical weather and the most recent measured weather data.

Data from these machine learning capabilities can then be used to optimize solar power use gathered by the solar cell 9. For example, as shown in FIG. 5A, a portion of the solar power gathered by the solar cell 9 can be used to power the pump 3 of the irrigation system 2, while a remaining portion can be passed to the battery 11 for storage for future use. The stored energy from the battery 11 can then be used to run the irrigation system 2 on days in which solar power is limited, e.g., cloudy days, one or more solar cells 9 being down, and the like. Management of the solar power can be performed by Level 2 of the controller 10, as shown, in which MPC and a smaller prediction horizon can manage the energy from the energy storage to meet the Level 3 irrigation schedule. In Level 2, the controller 10 can manage the energy source to minimize battery aging and replacement costs. For example, energy can be predicted over sub-daily periods and the controller can manage the amount that the energy is stored and depleted to reduce the replacement cost and mitigate errors in the longer term predictions. It will be appreciated that if there is an error in the weather prediction in Level 3, Level 2 of the controller can adjust for the error in real-time and apportion energy to the pump 3 and to the battery 11 appropriately.

Management of pumping the water to the farm 1 can be controlled by Level 1 of the controller architecture 130. In Level 1, proportional-integral-derivative control and pressure feedback can be used to maintain uniform flow and auto-adjusts the pump operating point during fluctuations in system pressure drop, which can maintain the system at its ideal operation point. Modifying the scheduling of the irrigation events with the controller 10 using profile matching can reduce the power system cost by about 30% as compared to conventional solar-powered irrigation systems.

FIG. 5B illustrates the interaction between the levels of the controller architecture 130 in greater detail. As shown, in Level 3, the MPC can leverage weather stations 132 to combine current weather data with past weather data to model future weather that can create a soil and solar model. In this model, the MPC can create data points for initial and predicted water, e.g., daily, and solar, e.g., hourly, and use this data to create an ideal optimization schedule based on this data. Additionally, and/or alternatively, the optimization schedule can also take data from the battery when making the ideal schedule.

The initial and predicted water and solar data can be passed to Level 2 of the controller architecture 130 along with the ideal schedule formulated by the MPC. In some embodiments, Level 2 can include measured solar data from the weather station 132 to optimize use of the battery 11, e.g., extend and/or maintain battery life. The output of Level 2 can include a battery charge rate that can be passed to the battery 11, which can manage the energy for energy storage based, at least in part, on the irrigation schedule from Level 3. In some embodiments, optimization of use of the battery 11 can allow for use of smaller batteries than conventional systems and extend reliability of such smaller batteries, thereby further reducing costs of the system 2. Level 1 of the controller architecture 130 can be in communication with a pressure monitor, pressure sensor, or pressure gauge 134 to provide proportional pressure. As shown, Level 1 can use the pressure monitor 134 to measure pressure and provide control and feedback from the pressure sensor to maintain uniform flow and/or adjustments if needed. The pressure data from Level 1 can be communicated to the optimization schedule in Level 3 for consideration of adjustment of the schedule by the MPC.

The controller architecture 130 can allow the controller 10 to simulate anticipated operation of the irrigation system 2, thereby optimizing the components for lowest cost, highest profit, and so forth. Insets (I) and (II) of FIG. 5B illustrate the system design software of the tool that operates capabilities of the controller at each level of its architecture.

As shown, inset (I) illustrates the predicted irrigation (E), predicted solar power (F), and predicted pump Power (G) for day 1, while inset (II) illustrates these values for day 2. When actual irrigation is delivered on day 1, this data can be communicated to the irrigation optimization schedule to adjust the predictions for day 2, as shown by irrigation delivered (H), actual solar power (I), and actual pump power (J) in inset (II). These adjustments can occur throughout the day, e.g., sub-hourly, every three hours, every hour, every thirty minutes, every fifteen minutes, every ten minutes, every five minutes, and/or every minute, and/or at the conclusion of irrigation at each full day, among other possible time periods. During day 2, the data can then be communicated to the irrigation optimization schedule with said curves being updated for day 3, and so forth.

The controller 10 of the present embodiments can improve the current irrigation practices observed on farms in several ways. First, the controller 10 can eliminate any challenges with irrigation scheduling or energy management. Specifically, because many farmers set their irrigation schedules based on weather, cloudy days can be particularly problematic for conventional systems and methods due to the inability to anticipate how much irrigation would be needed. Moreover, due to the unpredictability of weather, farmers had trouble getting enough power from their system to pump the amount of water that was needed if the weather suddenly changed. Further still, a majority of farmers make decisions about when to start and stop irrigation events based on experience and/or observations at a single point in time, which is a practice that does not account for future weather or crop water demands. Instead, by taking all of the sensed data (though, as noted above, not necessarily at a high cost of too many and/or more sophisticated sensors) and manual inputs into account, the controller 10 can determine an optimal amount of power available for the remainder of the week, and ensure that water can be available for distribution to crops and stored at rates that will reduce risk to the crops. Second, the controller can remedy the inefficiencies of current systems by using the power available in efficient ways to minimize costs while providing crops with the volume of water needed to promote optimal yields, as discussed with respect to Level 2 of the controller architecture above.

One exemplary embodiment of a system for irrigating a field can include controlling means comprising a model predictive control (MPC), a mapping of the field into one or more sections, a means for pumping water to each section of the field, e.g., a pump, and a means of communication from the MPC to the farmer. The MPC algorithm can optimize an irrigation schedule, manage energy from energy storage, and maintain uniform flow of irrigation. The communication can include instructions, such as an irrigation schedule for each section of the field, or directions for the user to take. The reference to “means” in the present disclosure can include other such features provided for herein or otherwise known to those skilled in the art.

In some embodiments, the system can include a renewable energy source that can be utilized, monitored, and regulated by the MPC. The system can further include sensors to monitor crop, soil, and weather conditions of the farm field, wherein the MPC integrates information from the sensors. Moreover, the system can include a means of communication from the MPC to the means for pumping water, e.g., Wi-Fi signal, Bluetooth connection, and so forth, wherein MPC automates the means for pumping water, e.g., a pump of one or more sections of the field. The pump can be manually controlled by the farmer. The MPC can include a computer system that include a processing system, a computer storage accessible to the processing system, and computer program instructions encoded on the computer storage, wherein when the computer program instructions are processed by the processing system. The computer system can be configured to define data structures in the computer storage representing each section of the farm field, energy conditions from energy storage, and weather conditions; and execute an algorithm applied to the data structures to produce an irrigation schedule based on water demand. In some embodiments, the controller can predict a weather condition based on the sensed data, and feed the weather condition to the optimal control, e.g., the MPC, to create the optimal irrigation schedule.

In some embodiments of the present disclosure, a computer program product can include computer storage and computer program instructions encoded on the computer storage. The computer program instructions, when processed by a processing system of a computer, can cause the computer to implement the computer system having a processing system and a computer storage accessible to the processing system.

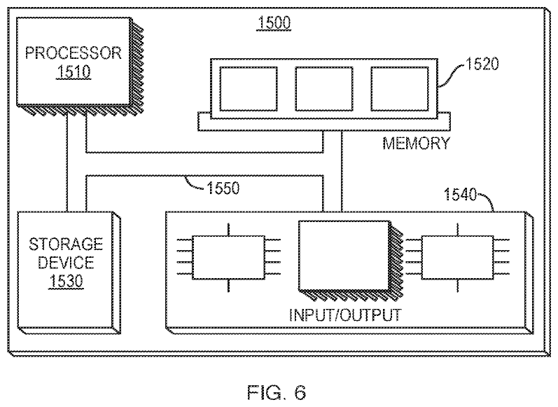

FIG. 6 is a block diagram of one exemplary embodiment of a computer system 1500 upon which the controller 10 or control system of the present disclosures can be built, performed, trained, etc. For example, any devices or systems can be examples of the system 1500 described herein. The system 1500 can include a processor 1510, a memory 1520, a storage device 1530, and an input/output device 1540. Each of the components 1510, 1520, 1530, and 1540 can be interconnected, for example, using a system bus 1550. The processor 1510 can be capable of processing instructions for execution within the system 1500. The processor 1510 can be a single-threaded processor, a multi-threaded processor, or similar device. The processor 1510 can be capable of processing instructions stored in the memory 1520 or on the storage device 1530. The processor 1510 may execute operations such as, by way of non-limiting examples, instruct the tool to communicate with the irrigation system 2 to increases and/or decrease water flow to the farm 1, communicate with the user to update the irrigation schedule and/or provide a new direction, or the like. The controller 1500 can optimize operation in response to energy management and water use, as discussed above. The controller 1500 may further embed machine-learning techniques, artificial intelligence, and/or digital twinning that can aid in improving performance.

The memory 1520 can store information within the system 1500. In some implementations, the memory 1520 can be a computer-readable medium. The memory 1520 can, for example, be a volatile memory unit or a non-volatile memory unit. In some implementations, the memory 1520 can store information related to weather data, farm inputs, and so forth.

The storage device 1530 can be capable of providing mass storage for the system 1500. In some implementations, the storage device 1530 can be a non-transitory computer-readable medium. The storage device 1530 can include, for example, a hard disk device, an optical disk device, a solid-date drive, a flash drive, magnetic tape, and/or some other large capacity storage device. The storage device 1530 may alternatively be a cloud storage device, e.g., a logical storage device including multiple physical storage devices distributed on a network and accessed using a network. In some implementations, the information stored on the memory 1520 can also or instead be stored on the storage device 1530.

The input/output device 1540 can provide input/output operations for the system 1500. In some implementations, the input/output device 1540 can include one or more of network interface devices (e.g., an Ethernet card or an InfiniBand interconnect), a serial communication device (e.g., an RS-232 10 port), and/or a wireless interface device (e.g., a short-range wireless communication device, an 802.7 card, a 3G wireless modem, a 4G wireless modem, a 5G wireless modem). In some implementations, the input/output device 1540 can include driver devices configured to receive input data and send output data to other input/output devices, e.g., a keyboard, a printer, and/or display devices. In some implementations, mobile computing devices, mobile communication devices, and other devices can be used.

In some implementations, the system 1500 can be a microcontroller. A microcontroller is a device that contains multiple elements of a computer system in a single electronics package. For example, the single electronics package could contain the processor 1510, the memory 1520, the storage device 1530, and/or input/output devices 1540.

Although an example processing system has been described above, implementations of the subject matter and the functional operations described above can be implemented in other types of digital electronic circuitry, or in computer software, firmware, or hardware, including the structures disclosed in this specification and their structural equivalents, or in combinations of one or more of them. Implementations of the subject matter described in this specification can be implemented as one or more computer program products, i.e., one or more modules of computer program instructions encoded on a tangible program carrier, for example a computer-readable medium, for execution by, or to control the operation of, a system for scheduling irrigation events. The computer readable medium can be a machine-readable storage device, a machine-readable storage substrate, a memory device, a composition of matter effecting a machine-readable propagated signal, or a combination of one or more of them.

Various embodiments of the present disclosure may be implemented at least in part in any conventional computer programming language. For example, some embodiments may be implemented in a procedural programming language (e.g., “C” or ForTran95), in an object-oriented programming language (e.g., “C++”), and/or other programming languages (e.g. Java, JavaScript, PHP, Python, and/or SQL). Other embodiments may be implemented as a pre-configured, stand-along hardware element and/or as preprogrammed hardware elements (e.g., application specific integrated circuits, FPGAs, and digital signal processors), or other related components.

The term “computer system” may encompass all apparatus, devices, and machines for processing data, including, by way of non-limiting examples, a programmable processor, a computer, or multiple processors or computers. A processing system can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, executable logic, or code) can be written in any form of programming language, including compiled or interpreted languages, or declarative or procedural languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

Such implementation may include a series of computer instructions fixed either on a tangible, non-transitory medium, such as a computer readable medium. The series of computer instructions can embody all or part of the functionality previously described herein with respect to the system. Computer readable media suitable for storing computer program instructions and data include all forms of non-volatile or volatile memory, media and memory devices, including by way of example semiconductor memory devices, e.g., EPROM, EEPROM, and flash memory devices; magnetic disks, e.g., internal hard disks or removable disks or magnetic tapes; magneto optical disks; and CD-ROM and DVD-ROM disks. The processor and the memory can be supplemented by, or incorporated in, special purpose logic circuitry. The components of the system can be interconnected by any form or medium of digital data communication, e.g., a communication network. Examples of communication networks include a local area network (“LAN”) and a wide area network (“WAN”), e.g., the Internet.

Those skilled in the art should appreciate that such computer instructions can be written in a number of programming languages for use with many computer architectures or operating systems. Furthermore, such instructions may be stored in any memory device, such as semiconductor, magnetic, optical, or other memory devices, and may be transmitted using any communications technology, such as optical, infrared, microwave, or other transmission technologies.

Among other ways, such a computer program product may be distributed as a removable medium with accompanying printed or electronic documentation (e.g., shrink wrapped software), preloaded with a computer system (e.g., on system ROM or fixed disk), or distributed from a server or electronic bulletin board over the network (e.g., the Internet or World Wide Web). In fact, some embodiments may be implemented in a software-as-a-service model (“SAAS”) or cloud computing model, as provided for at least above with respect to the cloud computing 102 of FIG. 4A and as otherwise understood by a person skilled in the art. Of course, some embodiments of the present disclosure may be implemented as a combination of both software (e.g., a computer program product) and hardware. Still other embodiments of the present disclosure are implemented as entirely hardware, or entirely software.

The present disclosure is particularly beneficial because the controller and related methods provided for herein can be optimized at a farm-scale level. This affords flexibility to deal with the many load and energy management issues described herein, among other issues dealt with by the present disclosures and solved by the same. For example, the controller and related methods of the present disclosure can be used with different water sources and/or various hydraulic system configurations provided on a farm or across different farms. Further, implementation of the present controller, and related methods, allows for on-site weather determinations that enhance the ability to accurately predict weather, in turn providing for a more accurate algorithm implemented by the controller and related methods. Weather can vary significantly, even across a single, large farm, and thus the ability to monitor and account for the weather on-site enhances the performance of the controller and related methods.

Still further, the energy use optimization that results from the controller and related methods helps create off-grid, or minimal interaction with grid, solutions due to the optimization of battery life, or power source(s) more generally, built into the controlling algorithm. Because the controller and related methods are operated on a farm-scale level, this ability to monitor, control, and optimize power usage helps extend battery life by minimizing charging rate, among other load-balancing techniques provided for herein, providing cost and reliability benefits that off-grid users often struggle with when not implementing the present disclosures on their farm(s). Additional benefits are afforded by the present controller, and related methods, due to the use of profile matching. The optimal schedules that result from utilizing profile matching provide for optimization not previously implemented in irrigation management systems. The disclosures of the present embodiments can be varied out in a wide variety of context with similar results and performance. This because, at least in part, of the algorithms and equations used to monitor and optimize the various parameters accounted for herein.

Yet another benefit of the present disclosure is the implementation of the control, and related algorithms and methods, by way of a user interface and/or by providing for automated changes to the system. For example, in at least some embodiments, instructions of the present disclosure that result from the inputs are communicated to a user via an app, which the user can then implement on the farm. Further, the user can communicate with the app to inform that app as the instructions are carried out, which in turn can result in more instructions and/or can provide for additional inputs that are fed back into the algorithm for further use in generating additional information, instructions, etc. Alternatively, or additionally, in at least some embodiments, the inputs into the algorithm can generate automated responses within the irrigation system. Those responses can be communicated to the user via an app, and the user can likewise communicate with the app in this context to inform that app about the responses that were carried out and/or other actions taken by the user, the system, etc. Further, the schedules and other instructions provided for herein can be communicated across the various components of the systems disclosed.

Examples of the above-described embodiments can include the following:
1. An irrigation tool, comprising:
   a controller in communication with an irrigation system and a farm to receive one or more inputs therefrom to create an irrigation schedule, the controller being configured to:
      create a predictive model of the irrigation system based on the one or more inputs;
      optimize energy and water use to produce an optimal irrigation schedule using the predictive model;
      optimize the irrigation schedule using optimal control based on the predictive model; and
      prompt one or more irrigation system components of the irrigation system to operate based on the irrigation schedule.
2. The tool of example 1, wherein the one or more inputs comprise historical data, sensed data, or manually input data.
3. The tool of example 1 or example 2, wherein the sensed data comprises one or more of precipitation, evapotranspiration, solar light, solar irradiance, or water pressure in the irrigation system.
4. The tool of example 2 or example 3, wherein the controller is further configured to:
   predict a weather condition based on the sensed data, and
   feed the weather condition to the optimal control to create the optimal irrigation schedule.
5. The tool of any of examples 2 to 4, wherein the controller is in communication with one or more sensors that are configured to gather the sensed data.
6. The tool of any of examples 1 to 5, wherein the manually input data comprises one or more of farm size details, crop selection, growth cycles, drip irrigation layout, or soil type.
7. The tool of any of examples 1 to 6, wherein the controller is configured to perform an irrigation scheduling technique with a renewable intermittent source that is predicted with the one or more inputs to calculate at least one of solar power available, evapotranspiration, or crop water demand.
8. The tool of example 7, wherein the renewable intermittent source comprises solar energy.
9. The tool of example 7 or example 8, wherein the irrigation scheduling technique comprises one or more of profile matching or a single section operation schedule.
10. The tool of any of examples 1 to 9, wherein the optimal control is a model predictive control (MPC).
11. The tool of any of examples 1 to 10 wherein the optimal irrigation schedule includes profile matching.
12. The tool of any of examples 1 to 11, wherein the controller is in communication with a mobile device of a user, the controller being configured to send and receive prompts from the mobile device.
13. The tool of example 12, wherein the prompts comprise one or more of the irrigation schedule or one or more commands for a user action.
14. The tool of example 12 or example 13, wherein the one or more commands further comprises one or more prompts to manually open or close one or more valves of the irrigation system.
15. The tool of any of examples 12 to 14, wherein the controller is further configured to update the irrigation schedule based on a prompt received from the mobile device.
16. The tool of any of examples 1 to 15, wherein the controller is further configured to open or close one or more automatic valves of the irrigation system.
17. The tool of any of examples 1 to 16, wherein the one or more irrigation system components further comprise a pump, a solar panel, one or more of a manually operated vale or an automatic valve, and one or more of a tank or a power source battery.
18. The tool of any of examples 1 to 17, wherein the controller calculates soil moisture data without being in communication with soil moisture sensors.
19. A method of irrigation, comprising:
   using a controller in communication with an irrigation system and a farm:
      creating an irrigation schedule based on one or more inputs received from the irrigation system or the farm;
      optimizing energy and water use to produce an optimal irrigation schedule;
      optimizing the irrigation schedule using optimal control based on based on a model of the irrigation system that allows for predictions of future system behavior; and
      prompting one or more components of the irrigation system to operate based on the irrigation schedule.
20. The method of example 19, further comprising performing profile matching with a renewable intermittent source that is predicted with the one or more inputs to calculate at least one of solar power available, evapotranspiration, or crop water demand.
21. The method of example 19 or example 20, wherein the optimal control is a model predictive control (MPC).
22. The method of any of examples 19 to 21, wherein the optimal irrigation schedule includes profile matching.
23. The method of any of examples 19 to 22, further comprising communicating, using the controller, with a mobile device to send and receive prompts from the mobile device.
24. The method of example 23, further comprising adjusting the irrigation schedule, using the controller, based on a prompt received from the mobile device.
25. The method of example 24, wherein the prompt comprises one or more of the irrigation schedule or one or more commands for the user.
26. The method of example 25, wherein the one or more commands directs for manually opening or closing a valve of the irrigation system based on the command.
27. The method of any of examples 19 to 26, wherein creating the irrigation schedule further comprises creating a predictive model based on agronomy models and weather data that are used to create the irrigation schedule.
28. The method of example 27, wherein the predictive model is created in approximately a range of about sub-hourly to about one week in advance of operation based on the irrigation schedule.
29. The method of example 28, further comprising adjusting the predictive model, using the controller, between a time that the predictive model is created and a time in which one or more components of the irrigation system is prompted to operate based on the irrigation schedule.
30. The method of any of examples 19 to 29, further comprising adjusting, using the controller, one or more of the irrigation schedule, amount of power available, or pumping power in response to changes in weather patterns, soil water balance, sensed data, or manual inputs into the controller.
31. The method of any of examples 19 to 30, wherein optimizing energy use further comprises extending a battery life of a battery associated with the irrigation system.

One skilled in the art will appreciate further features and advantages of the disclosures based on the provided for descriptions and embodiments. Accordingly, the inventions are not to be limited by what has been particularly shown and described. All publications and references cited herein are expressly incorporated herein by reference in their entirety.

Some non-limiting claims are provided below.

What is claimed is:

1. An irrigation tool, comprising:
a controller in communication with an irrigation system and a farm to receive one or more inputs therefrom to create an irrigation schedule, the controller being configured to:
create a predictive model of the irrigation system based on the one or more inputs;
optimize energy and water use to produce an optimal irrigation schedule using the predictive model;
optimize the irrigation schedule using optimal control based on the predictive model; and
prompt one or more irrigation system components of the irrigation system to operate based on the irrigation schedule.

2. The tool of claim 1, wherein the one or more inputs comprise at least one of historical data, sensed data, or manually input data.

3. The tool of claim 2, wherein the sensed data comprises one or more of precipitation, evapotranspiration, solar light, solar irradiance, or water pressure in the irrigation system.

4. The tool of claim 2, wherein the controller is further configured to:
predict a weather condition based on the sensed data, and
feed the weather condition to the optimal control to create the optimal irrigation schedule.

5. The tool of claim 4, wherein the controller is configured to perform an irrigation scheduling technique with a renewable intermittent source that is predicted with the one or more inputs to calculate at least one of solar power available, evapotranspiration, or crop water demand.

6. The tool of claim 4, wherein the irrigation scheduling technique comprises one or more of profile matching or a single section operation schedule.

7. The tool of claim 1, wherein the optimal control is a model predictive control (MPC).

8. The tool of claim 1, wherein the controller is in communication with a mobile device of a user, the controller being configured to send and receive prompts from the mobile device.

9. The tool of claim 8, wherein the prompts comprise one or more of the irrigation schedule or one or more commands for a user action.

10. The tool of claim 8, wherein the controller is further configured to update the irrigation schedule based on a prompt received from the mobile device.

11. The tool of claim 1, wherein the one or more irrigation system components further comprise a pump, a solar panel, one or more of a manually operated valve or an automatic valve, and one or more of a tank or a power source battery.

12. The tool of claim 1, wherein the controller calculates soil moisture data without being in communication with soil moisture sensors.

13. A method of irrigation, comprising:
using a controller in communication with an irrigation system and a farm:
creating an irrigation schedule based on one or more inputs received from the irrigation system or the farm;
optimizing energy and water use to produce an optimal irrigation schedule;
optimizing the irrigation schedule using optimal control based on a model of the irrigation system that allows for predictions of future system behavior; and
prompting one or more components of the irrigation system to operate based on the irrigation schedule.

14. The method of claim 13, further comprising performing profile matching with a renewable intermittent source that is predicted with the one or more inputs to calculate at least one of solar power available, evapotranspiration, or crop water demand.

15. The method of claim 13, further comprising communicating, using the controller, with a mobile device to send and receive prompts from the mobile device.

16. The method of claim 15, further comprising adjusting the irrigation schedule, using the controller, based on a prompt received from the mobile device.

17. The method of claim 13, wherein creating the irrigation schedule further comprises creating a predictive model based on agronomy models and weather data that are used to create the irrigation schedule.

18. The method of claim 17, wherein the predictive model is created in approximately a range of about sub-hourly to about one week in advance of operation based on the irrigation schedule.

19. The method of claim 18, further comprising adjusting the predictive model, using the controller, between a time that the predictive model is created and a time in which one or more components of the irrigation system is prompted to operate based on the irrigation schedule.

20. The method of claim 13, further comprising adjusting, using the controller, one or more of the irrigation schedule, amount of power available, or pumping power in response to changes in weather patterns, soil water balance, sensed data, or manual inputs into the controller.

21. The method of claim 13, wherein optimizing energy use further comprises extending a battery life of a battery associated with the irrigation system.
